(19) United States
(12) Patent Application Publication
(10) Pub. No.: US 2007/0114802 A1
(43) Pub. Date: May 24, 2007

(54) Door striker

(76) Inventors: Lawrence W. Johnson, Taylor, MI (US); Todd Gerlach, South Lion, MI (US)

Correspondence Address: ILLINOIS TOOL WORKS INC., 3600 WEST LAKE AVENUE, PATENT DEPARTMENT, GLENVIEW, IL, 60025, US

(21) Appl. No.: 11/488,343

(22) Filed: Jul. 18, 2006

Related U.S. Application Data
(60) Provisional application No. 60/734,492, filed on Nov. 8, 2005.

(51) Int. Cl. E05B 15/02

(52) U.S. Cl. 292/340

(57) ABSTRACT

A door striker for use with an automobile door latching assembly having a latch positioned within a gap defined by an edge. The door striker includes a bar configured to be securably engaged by the latch of the latching assembly and a bumper positioned proximate the bar and configured to be received within the gap of the latching assembly to resistably engage the edge of the gap when the latching assembly moves with respect to the bar.

### RELATED APPLICATIONS

This application relates to and claims priority benefits from U.S. Provisional Patent Application No. 60/734,492 entitled “Door Striker,” filed Nov. 8, 2005, which is hereby incorporated by reference in its entirety.

### FIELD OF THE INVENTION

Embodiments of the present invention generally relate to a door striker used to engage a latch, and more particularly to a door striker used to engage a latch on an automobile door to secure the automobile door in a closed position.

### BACKGROUND OF THE INVENTION

A conventional automobile door, such as a trunk, tailgate, or hatchback door, is secured in a closed position by a latch and striker assembly. The door includes a latch that engages a door striker when the door is closed such that the latch is secured about the striker and the door is held in the closed position. FIG. 1 illustrates a back view of an automobile 10 with a rear door 14 in the open position and a conventional door striker 18 positioned in the door frame 16 proximate the rear bumper 22 of the automobile 10. The rear door 14 includes a latch assembly 26 for engaging the door striker 18 and securing the door 14 in the closed position.

FIG. 2 illustrates the door striker 18. The door striker 18 is U-shaped and mounted to a base 30. The door striker 18 includes a rear bar 34 extending vertically up from the base 30.

FIG. 3 illustrates the latch assembly 26. The latch assembly 26 includes a rotatable latch 38 positioned in a U-shaped gap 42. When the door 14 is closed, the bar 34 is received within the gap 42 and the bar 34 engages the latch 38 such that the latch 38 rotates around the bar 34 to secure the bar 34 within the gap 42 of the latch assembly 26.

FIG. 4 illustrates a cutaway top view of the bar 34 positioned within the gap 42 and secured by the latch 38. Because the width of the gap 42 is significantly greater than the width of the bar 34, the latch assembly 26, and therefore the door 14, are free to move laterally in the directions of Arrows A and B when the bar 34 is secured in the gap 42 by the latch 38. Accordingly, when the door 14 is closed and the automobile 10 is in motion, the closed door 14 is susceptible to shaking and rattling about the striker 18 as the latch assembly 26 moves back and forth in the directions of Arrows A and B about the bar 34. This shaking and rattling can damage the latch assembly and generate noises that distract the driver of the automobile.

Thus, a need exists for an automobile door latch/striker assembly that reduces rattling and shaking of the door when the automobile is moving. In particular, a need exists for a door striker that engages a latch assembly such that movement of the latch assembly about the striker is reduced.

### SUMMARY OF THE INVENTION

Certain embodiments of the present invention provide a door striker for use with an automobile door latching assembly having a latch positioned within a gap defined by an edge. The door striker includes a bar configured to be securably engaged by the latch of the latching assembly and a bumper positioned proximate the bar and configured to be received within the gap of the latching assembly to resistably engage the edge of the gap when the latching assembly moves with respect to the bar.

Certain embodiments of the present invention provide a door striker for use with an automobile door latching assembly having a latch positioned within a gap defined by an edge. The door striker includes a base plate, a back plate, a bar extending from the base plate to the back plate and being configured to be securably engaged by the latch of the latching assembly, and a bumper extending from at least one of the back plate and base plate. The bumper is configured to be received within the gap of the latching assembly to resistibly engage the edge of the gap when the latching assembly moves with respect to the bar.

Certain embodiments of the present invention provide an automobile door latching system. The system includes an automobile door mounted in a frame and having a latching assembly. The latching assembly includes a latch positioned within a gap defined by an edge. The system includes a door striker mounted in the frame of the automobile door and having a base plate, a back plate extending from the base plate, a bar extending from the base plate to the back plate and being configured to be securably engaged by the latch, and a bumper extending from the base plate. The bumper is configured to be received within the gap of the latching assembly to resistibly engage the edge of the gap when the latching assembly moves with respect to the bar.

### BRIEF DESCRIPTION OF SEVERAL VIEWS OF THE DRAWINGS

FIG. 1 illustrates a rear view of an automobile with an open back door.

FIG. 2 illustrates an isometric view of a conventional automobile door striker.

FIG. 3 illustrates an isometric view of a conventional automobile door latch assembly.

FIG. 4 illustrates a cutaway top view of the striker of FIG. 2 engaging the latch assembly of FIG. 3.

FIG. 5 illustrates an isometric view of a door striker according to an embodiment of the present invention.

FIG. 6 illustrates a side view of the door striker shown in FIG. 5.

FIG. 7 illustrates a front view of the door striker shown in FIG. 5.

FIG. 8 illustrates a top view of the door striker shown in FIG. 5.

FIG. 9 illustrates a side view of a door striker according to an embodiment of the present invention.

FIG. 10 illustrates a top cutaway view of the latch assembly of FIG. 3 engaging the door striker of FIG. 5.

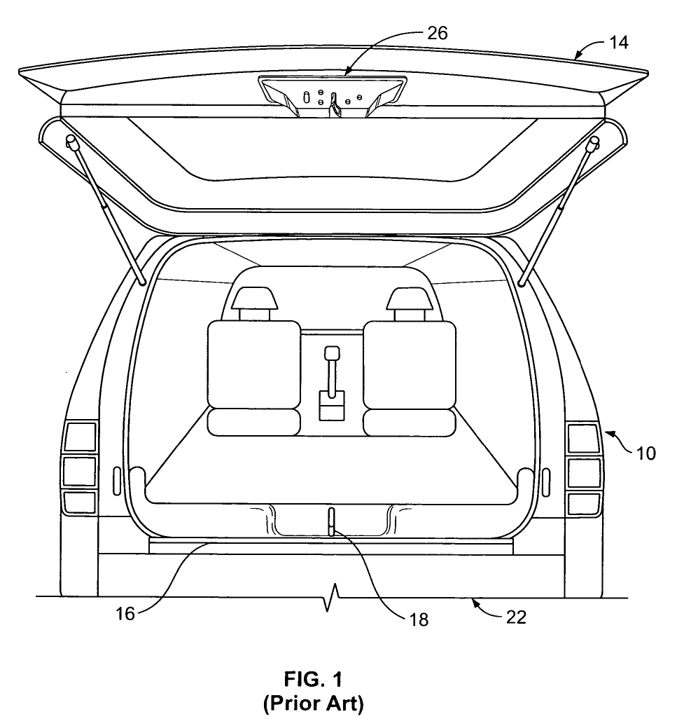

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE INVENTION

FIG. 5 illustrates an isometric view of a door striker 46 according to an embodiment of the present invention. The door striker 46 includes a generally triangular back plate 50 formed with, and extending generally perpendicularly from, a base plate 54. The door striker 46 includes an L-shaped cylindrical bar 58 that extends between the back plate 50 and base plate 54. The bar 58 includes a rear section 62 and a top section 66 that are generally perpendicular to each other and formed together at an elbow 72. The rear section is formed with, and extends from, a top surface 74 of the base plate 54, and the top section 66 is formed with, and extends from, a front surface 78 of the back plate 50. By way of example only, the back plate 50, base plate 54, and bar 58 may be made of metal. The base plate 54 includes holes 70 that are configured to receive fasteners configured to secure the base plate 54 to a base in the door frame of an automobile such that the door striker 46 is positioned to engage an automobile door latch. By way of example only, the fasteners may be screws or bolts. Alternatively, the back plate 50 may have holes configured to receive fasteners to mount the door striker 46 within a door frame of an automobile. By way of example only, the base plate 54 may be mounted in a door frame proximate the bumper of the automobile with the rear section 62 facing out from the backside of the automobile. The door striker 46 includes a wedge-shaped bumper 82 that extends from the front surface 78 of the back plate 50 under the top section 66 and toward the rear section 62 of the bar 58. The bumper 82 may be made of rubber or any other shock-absorbing material.

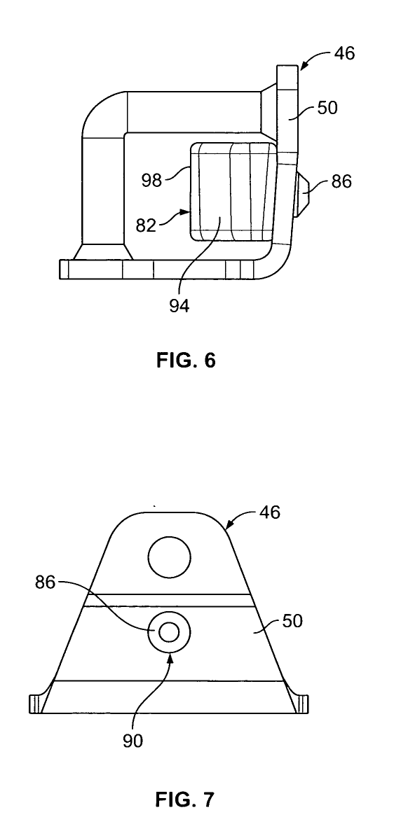

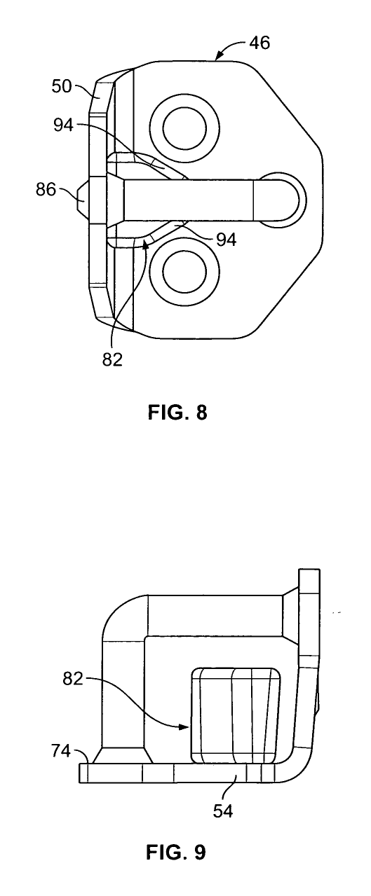

FIG. 6 illustrates a side view of the door striker 46 shown in FIG. 5, FIG. 7 illustrates a front view of the door striker 46 shown in FIG. 5, and FIG. 8 illustrates a top view of the door striker 46 shown in FIG. 5. Referring to FIGS. 6-8, the bumper 82 is secured to the back plate 50 by a knob 86 that extends from the bumper 82 through a hole 90 in the back plate 50. By way of example only, the knob 86 may be made of rubber and formed with the bumper 82. Alternatively, the bumper 82 may be secured to the back plate 50 by any number of other methods such as, by way of example only, fasteners, glue, or epoxy. Alternatively, as shown in FIG. 9, the bumper 82 may be secured to, and extend upward from, the top surface 74 of the base plate 54. Referring back to FIGS. 6 and 8, the bumper 82 includes side walls 94 that extend from the back plate 50 and that angle inward to meet at a nose 98 to define a generally triangular shape for the bumper 82. Alternatively, the bumper 82 may have any number of other shapes, such as, by way of example only, rectangular, or square.

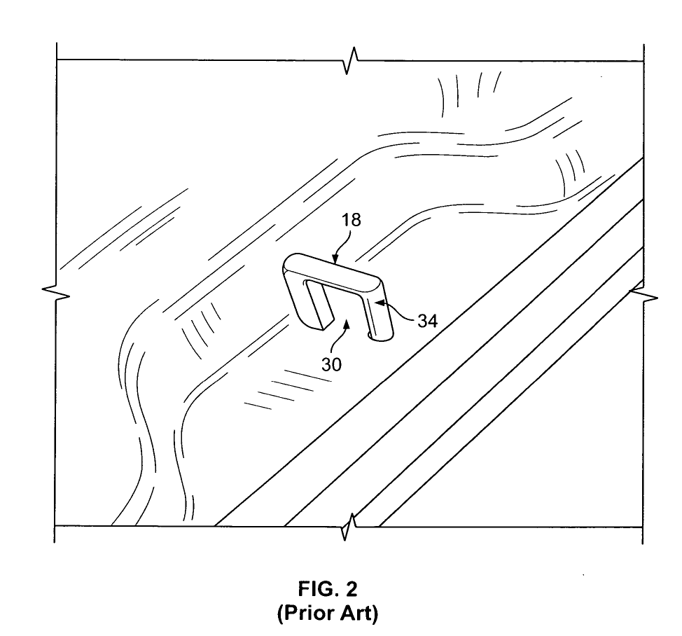

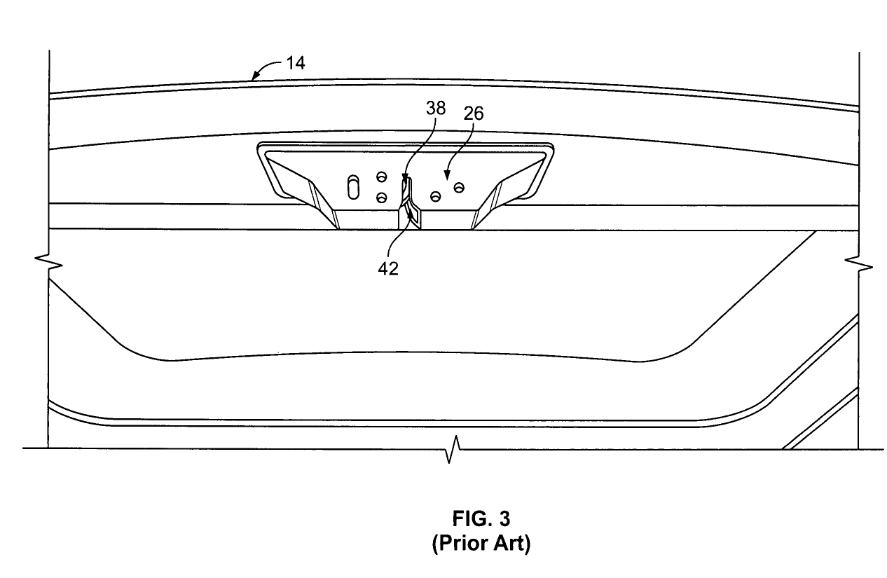

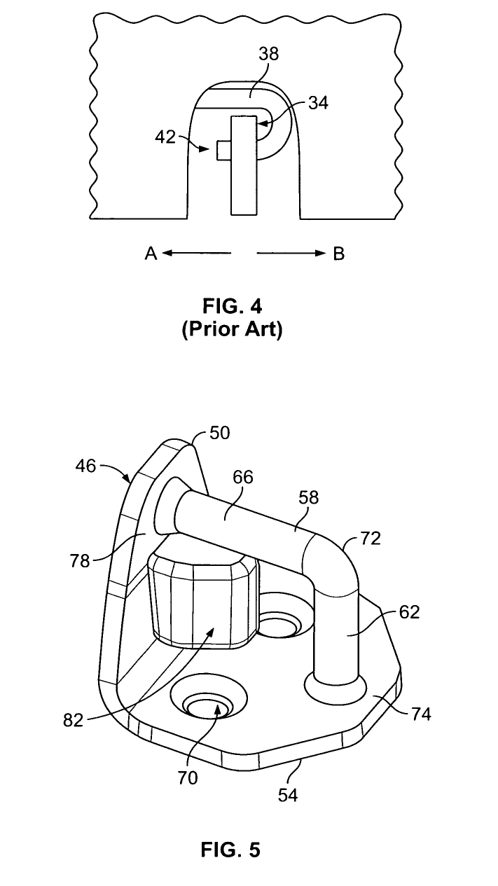

In operation, the door striker 46 is used with a conventional latch assembly such as the latch assembly 26 shown in FIG. 3 to secure an automobile door in the closed position. The door striker 46 is mounted to a base 30 (FIG. 2) of a door frame of the automobile proximate the rear bumper like the conventional door striker 18 shown in FIG. 2 and is positioned to engage the latch assembly 26.

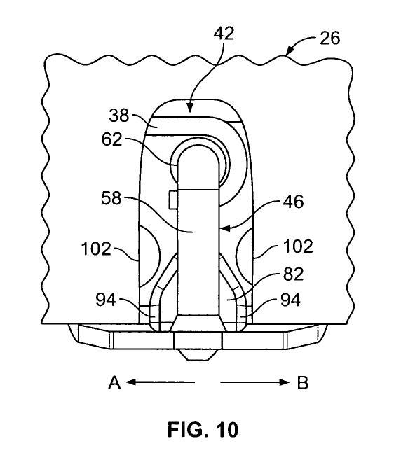

FIG. 10 illustrates a top cutaway view of the latch assembly 26 of FIG. 3 engaging the door striker 46 of FIG. 5. When the door is closed, the door striker 46 is received within the gap 42 of the latch assembly 26. The latch 38 engages, and rotates around, the rear section 62 of the bar 58 of the door striker 46 such that the latch 38 is secured about the rear section 62. The bumper 82 of the door striker 46 is received within the gap 42 of the latch assembly 26 such that the side walls 94 of the bumper 82 are positioned to engage side walls or an edge 102 that define the contours of the gap 42 of the latch assembly 26. The bumper 82 resists and blocks movement of the side walls or edge 102 of the latch assembly 26 to reduce lateral movement of the latch assembly 26 in the directions of Arrows A and B about the door striker 46.

The bumper 82 is configured to fill the gap 42 between the gap side walls 102 of the latch assembly 26 in order to minimize or otherwise reduce open space for movement of the latch assembly 26 about the door striker 46, and in turn reduce rattling by the latch assembly 26 and the rear door as the automobile is moving. Furthermore, because the bumper 82 is made of rubber, the bumper 82 on the door striker 46 reduces the amount of noise and wear generated by the latch assembly 26 moving about the door striker 46. Also, the bumper 82 helps align the latch assembly 26 with the door striker 46 as the bumper 82 is received within the U-shaped gap 42 of the latch assembly 26. Additionally, the bumper 82 may be deformable in order to accommodate the contours of the side walls 102 of the gap 42 as the latch assembly 26 is closed about the door striker 42, and thus be tightly compressed or fit between the side walls 102 of the gap 42 to further reduce movement of the latch assembly 26 about the door striker 46.

In an alternative embodiment, the door striker 42 may include the base plate 54—without the back plate 50—with the bumper 82 extending from the base plate 54. Alternatively, the door striker 42 may include the back plate 50—without the base plate 54—with the bumper 82 extending from the back plate 50. Alternatively, the back plate 50 and base plate 54 of the door striker may not be connected and/or may not be generally perpendicular to each other. In a further alternative embodiment, the door striker 42 may include a U-shaped bar extending from the base on the door frame of the automobile with the bumper 82 extending from the base under the bar without the base plate 54 or back plate 50. In another alternative embodiment, the bar 58 may be any number of other shapes besides cylindrical such as, by way of example only, rectangular. In another alternative embodiment, the door striker 46 may be used with any vehicle door besides a rear door.

The different embodiments of the door striker of the present invention provides several advantages over a conventional door striker. The bumper of the door striker engages the edge of the gap of the latch assembly to reduce rattling by the automobile door, and thus reduces wear on the latching assembly and striker and reduces distracting noises for the driver. Additionally, the bumper of the door striker is configured to be received within the gap of the latch assembly to better align the latch assembly with the door striker when the door is closed.

While various spatial terms, such as, for example, upper, lower, mid, lateral, horizontal, vertical, top, back, rear, front and the like may used to describe portions of the door striker and/or door striker/latch assembly, it is understood that such terms are merely used with respect to the orientations shown in the drawings. The orientations may be inverted, rotated, or otherwise changed, such that an upper portion is a lower portion, and vice versa, horizontal becomes vertical, and the like.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

1. A door striker for use with an automobile door latching assembly having a latch positioned within a gap defined by an edge, the door striker comprising:
a bar configured to be securably engaged by the latch of the latching assembly; and
a bumper positioned proximate said bar and configured to be received within the gap of the latching assembly to resistably engage the edge of the gap when the latching assembly moves with respect to said bar.

2. The door striker of claim 1, further including a base plate from which said bar extends, said base plate being configured to be secured to a door frame of an automobile.

3. The door striker of claim 1, further including a back plate from which said bumper and said bar extend.

4. The door striker of claim 1, wherein said bumper is rubber.

5. The door striker of claim 1, wherein said bumper is wedge-shaped.

6. The door striker of claim 1, wherein said bar is defined by a rear section formed generally perpendicularly with a top section, said rear section being engaged by the latching assembly.

7. The door striker of claim 1, further including a back plate, said bumper extending from said back plate and being connected to said back plate by a knob extending therethrough.

8. The door striker of claim 1, further including a base plate formed generally perpendicularly with a back plate, said bar extending from said back plate to said base plate and said bumper extending from said back plate.

9. The door striker of claim 1, wherein said bumper is configured to deform to fit within the gap of the latch assembly.

10. A door striker for use with an automobile door latching assembly having a latch positioned within a gap defined by an edge, the door striker comprising:
a base plate;
a back plate,
a bar extending from said base plate to said back plate and being configured to be securably engaged by the latch of the latching assembly; and
a bumper extending from at least one of said back plate and base plate, said bumper being configured to be received within the gap of the latching assembly to resistibly engage the edge of the gap when the latching assembly moves with respect to said bar.

11. The door striker of claim 10, wherein said base plate is configured to be secured to a door frame of an automobile.

12. The door striker of claim 10, wherein said bumper is rubber.

13. The door striker of claim 10, wherein said bumper is wedge-shaped.

14. The door striker of claim 10, wherein said bar is defined by a rear section formed generally perpendicularly with a top section, said rear section extending from said base plate and said top section extending from said back plate, said rear section being engaged by the latching assembly.

15. The door striker of claim 10, wherein said bumper extends from said back plate and is connected to said back plate by a knob extending therethrough.

16. The door striker of claim 10, wherein said bumper is configured to deform to fit within the gap of the latch assembly.

17. An automobile door latching system, comprising:
an automobile door mounted in a frame and including a latching assembly, said latching assembly including a latch positioned within a gap defined by an edge; and
a door striker mounted in said frame of said automobile door and including a base plate, a back plate extending from said base plate, a bar extending from said base plate to said back plate and being configured to be securably engaged by said latch, and a bumper extending from at least one of said back plate and said base plate, said bumper being configured to be received within said gap of said latching assembly to resistibly engage said edge of said gap when said latching assembly moves with respect to said bar.

18. The door striker of claim 17, wherein said bumper is rubber.

19. The door striker of claim 17, wherein said bumper is wedge-shaped.

20. The door striker of claim 17, wherein said bumper is configured to deform to fit within said gap of said latch assembly.
